(19) United States
(12) Patent Application Publication
(10) Pub. No.: US 2010/0103832 A1
(43) Pub. Date: Apr. 29, 2010

(54) Feedback Apparatus, Feedback Method, Scheduling Apparatus, And Scheduling Method

(75) Inventors: Hua Zhou, Beijing (CN); Hiroyuki Hayashi, Beijing (CN)

Correspondence Address: HANIFY & KING PROFESSIONAL CORPORATION, 1055 Thomas Jefferson Street, NW, Suite 400, WASHINGTON, DC, 20007, US

(73) Assignee: FUJITSU LIMITED, KAWASAKI (JP)

(21) Appl. No.: 12/525,266

(22) PCT Filed: Aug. 31, 2007
(86) PCT No.: PCT/CN2007/070610

§ 371 Date: Dec. 31, 2009

(51) Int. Cl. H04B 7/005; H04L 12/26; H04L 27/28

(52) U.S. Cl. 370/252; 455/69; 375/260

(57) ABSTRACT

A scheduling apparatus in a MIMO control station for switching between SU-MIMO mode and MU-MIMO mode receives feedback information from each of a plurality of MIMO terminals. The scheduling apparatus comprises a SU-MIMO selecting unit that selects a terminal that has a SU-MIMO optimal performance metric among all the terminals; a MU-MIMO selecting unit that groups the terminals into at least one set, and selects a set of terminals that have a MU-MIMO optimal performance metric; and a switching unit that compares the SU-MIMO optimal performance metric and the MU-MIMO optimal performance metric to switch between the SU-MIMO mode and the MU-MIMO mode.

### FIELD OF THE INVENTION

The present invention relates to wireless communication, and in particular to feedback apparatus, feedback method, scheduling apparatus, and scheduling method in a multiple-input multiple-output (MIMO) communication system.

### BACKGROUND OF THE INVENTION

MIMO wireless channels, created by exploiting antenna arrays at control station and terminal, promise high capacity and high-quality wireless communication links. When deployed in a cellular network with multiple terminals, a MIMO scheme should consider the interference not only between streams for one terminal, but also between streams for different terminals. In the current industry wireless communication standard, such as IEEE 802.16E (Document 1), the issue how to control interference between streams for single user in MIMO, i.e. SU-MIMO (single-user MIMO, communicating between one control station and one terminal both with multiple antennas), has been deeply addressed with limited feedback design.

As for transmission control for multiple users in MIMO, i.e. MU-MIMO (multiple-user MIMO, communicating between one control station and multiple terminals all with multiple antennas), there has not been achieved consensus on the method description. However, there have already been many proposals on how to support multiple user transmission on the same MIMO channel (Documents 2-6) in the study item of 3GPP LTE.

Basically, in terms of channel state information availability at the control station, these methods can be categorized into two classes. One is called “codebook based” where the control station do not need full channel information but only a quantized channel vector (in the form of channel vector index feedback). The other is called “non-codebook based” where the control station does need full channel information, by means of possible uplink sounding method.

Currently, in 3GPP LTE, there are mainly two kinds of proposals for MU-MIMO under the name of codebook based scheme, namely unitary precoding (Document 3) and non-unitary precoding. Here, unitary means codewords in the codebook (e.g. a codebook in the form of a DFT matrix) are orthogonal, while non-unitary means codewords in the codebook are not orthogonal.

In codebook based scheme, a codebook is maintained at the MIMO control station and the MIMO terminal. The codebook includes predefined weighting vectors, i.e. codewords, each of which is associated with a codeword index. In operation, the MIMO terminal will determine a best CQI (channel quality indicator) and select the most appropriate codeword from the codebook according to the best CQI. The MIMO terminal will send the CQI and the index of the selected codeword to the MIMO control station as feedback information. The MIMO control station will schedule user signals for multiple MIMO terminals according to the CQIs thereof, determine a weighting vector corresponding to the index from the scheduled terminal, and apply the determined weighting vector to the user signal for precoding before transmitting the user signal to the MIMO terminal.

For MU-MIMO communication, in unitary precoding, the codebook with orthogonal vectors can be constructed by some basic math rule, for example, the top n_{T} rows of DFT matrix with the size N (=2B) may be a such kind of codebook, as indicated by the following equation,

$${f}_{n} ( l ) = exp ( - \frac{j 2 π nl}{N} ) , l = 0 , … , {n}_{T} ; \\ n = 0 , … , N - 1 \qquad ( 1 )$$

wherein, B is the number of bits for indicating the size of a codebook (for a codebook having four codewords, B is 2); j is imaginary number; fₙ(l) is the l-th element of the n-th vector, and n_{T} and N are the number of transmit antennas and codebook size, respectively. In unitary precoding, the codebook is unitary matrix-based, i.e., the N vectors compose P=N/M unitary matrices, where M is the transmit streams, and the p-th unitary matrix is denoted as Fp=[fₚ, f_{p+P}, f_{p+2P}, . . . ](p=0, . . . , P−1), fₚ the p-th vector. The same unitary matrix-based codebook is utilized at both the control station (Node B) and the terminal (UE side) in unitary precoding.

In unitary precoding, the CQI may be calculated as:

$${CQI}_{k} {arg max}_{i , j ∈ [ 1 , … P ]} ( \frac{{\vert {H}_{k} {F}_{i} \vert}^{2}}{{σ}^{2} + {\sum }_{j \neq i}^{ } {\vert {H}_{k} {F}_{j} \vert}^{2}} ) \qquad ( 2 )$$

wherein H is a channel matrix, F is a weighting matrix, σ² is a noise power, and k is a user index. Note that the CQI computation includes all interference from other precoding vectors except of its own. In this case, the CQI is heavily underestimated, so that the whole multiple user throughput is not utilized sufficiently.

On the other hand, for non-unitary precoding, the CQI is calculated as:

$${CQI}_{k} {arg max}_{i , j ∈ [ 1 , … P ] , {\vert {F}_{i} {F}_{j} \vert}^{2} < {ρ}_{thrd}} ( \frac{{\vert {H}_{k} {F}_{i} \vert}^{2}}{{σ}^{2} + {\vert {H}_{k} {F}_{j} \vert}^{2}} ) \qquad ( 3 )$$

here, F is a weighting matrix from a non-orthogonal codebook. Although, CQI computation has already considered the interference from other stream, but it cannot guarantee the precoding index the user which the control station (base station) select will really use precoding index in this CQI computation. Therefore, the CQI computation also possibly mismatch with the realistic capacity.

With multiple receiver antennas at each terminal, the base station may select only one user to transmit for each time slot with rank greater than one, or select multiple users for each time slot for multiplexing spatially, each user with rank one. In order to make appropriate decision for the control station, users have to feedback enough, but not oversized, channel information, i.e., the feedback mechanism has to be able to facilitate the BS to make decision between SU-MIMO and MU-MIMO with limited overhead.

In current 3GPP LTE working group, switch between SU-MIMO and MU-MIMO has not been deeply addressed, because the CQI generation for these two methods is assumed different for each own optimization, or strategically considered differently independently.

### PRIOR ART DOCUMENTS

Document 1—Part 16: Air Interface for Fixed Broadband Wireless Access Systems, IEEE P802.16 (Draft March 2007), Revision of IEEE Std 802.16-2004, as amended by IEEE Std 802.16f-2005 and IEEE 802.16e-2005.
Document 2—3GPP R1-072422, NTT DoCoMo, “Investigating on precoding scheme for MU-MIMO in E-UTRA downlink”.

### Document 3—3GPP, R1-060335, Samsung, “Downlink MIMO for EUTRA”.

Document 4—3GPP, R1-060495, Huawei, “Precoded MIMO concept with system simulation results in macrocells”.
Document 5—3GPP, R1-062483, Philips, “Comparison between MU-MIMO codebook-based channel reporting techniques for LTE downlink”.
Document 6—3GPP, R1-071510, Freescale Semiconductor Inc., “Details of zero-forcing MU-MIMO for DL EUTRA”.

### SUMMARY OF THE INVENTION

One object of the present invention is to provide a method for providing feedback information to a MIMO control station from a MIMO terminal, which generates unified feedback information for SU-MIMO and MU-MIMO.

Another object of the present invention is to provide a feedback apparatus in a MIMO terminal, which generates unified feedback information for SU-MIMO and MU-MIMO.

A further object of the present invention is to provide a scheduling apparatus in a MIMO control station, which is able to switch between SU-MIMO mode and MU-MIMO mode according to feedback information from terminals.

A still further object of the present invention is to provide a scheduling method in a MIMO control station, which is able to switch between SU-MIMO mode and MU-MIMO mode according to feedback information from terminals.

A still further object of the present invention is to provide a computer program product comprising codes for performing a feedback method in a MIMO terminal, which generates unified feedback information for SU-MIMO and MU-MIMO.

A still further object of the present invention is to provide a computer program product comprising codes for performing a scheduling method in a MIMO control station, which is able to switch between SU-MIMO mode and MU-MIMO mode according to feedback information from MIMO terminals.

According to an aspect of the present invention, a method for providing feedback information to a MIMO control station from a MIMO terminal, which operates as one of a set of MIMO terminals in a MU-MIMO mode in receiving a plurality of data streams, comprises steps of: calculating a plurality of CQIs respectively corresponding to the plurality of streams; determining, from a codebook, a codeword which results in a preferred SU-MIMO performance metric; and transmitting precoding vector index (PVI) of the determined codeword and its corresponding CQIs to the MIMO control station.

Further, in the feedback method, the SU-MIMO performance metric is a SU-MIMO capacity.

Further, in the feedback method, the step of determining the codeword determines a codeword that maximizes the SU-MIMO capacity.

Further, in the feedback method, the step of calculating the CQIs is performed using a linear or non-linear MIMO detection method.

Further, in the feedback method, the step of calculating the CQIs is performed by using a linear ZF or MMSE MIMO detection method.

According to another aspect of the present invention, a feedback apparatus in a MIMO terminal, which operates as one of a set of MIMO terminals in a MU-MIMO mode to communicate with a MIMO control station in receiving a plurality of data streams, comprises: a CQI calculating unit that determines a plurality of CQIs respectively corresponding to the plurality of streams; a PVI selecting unit that determines, from a codebook, a codeword which results in a preferred SU-MIMO performance metric; and a transmitting unit that transmits PVI of the determined codeword and its corresponding CQIs to the MIMO control station.

Further, in the feedback apparatus, the SU-MIMO performance metric is a SU-MIMO capacity.

Further, in the feedback apparatus, the codeword selected by the PVI selecting unit is a codeword that maximizes the SU-MIMO capacity.

Further, in the feedback apparatus, the CQI calculating unit uses a linear or non-linear MIMO detection method to calculate the CQIs.

Further, in the feedback apparatus, the CQI calculating unit uses a linear ZF or MMSE MIMO detection method to calculate the CQIs.

According to still another aspect of the present invention, a scheduling method in a MIMO control station for switching between SU-MIMO mode and MU-MIMO mode comprises steps of: receiving feedback information from each of a plurality of MIMO terminals, the feedback information including a PVI and corresponding CQIs; determining a terminal that has a SU-MIMO optimal performance metric among all the terminals; grouping the terminals into at least one set, terminals in each set having matched codeword with each other, and selecting a set of terminals that have a MU-MIMO optimal performance metric; and comparing the SU-MIMO optimal performance metric and the MU-MIMO optimal performance metric to switch between the SU-MIMO mode and the MU-MIMO mode.

Further, in the scheduling method, the SU-MIMO optimal performance metric is a maximum SU-MIMO capacity, and the MU-MIMO optimal performance metric is a maximum MU-MIMO capacity.

Further, in the scheduling method, the set of terminals are selected such that columns of precoding codeword from each terminal in the set are a permutated version of those from another different terminal in the set.

Further, in the scheduling method, the step of selecting a set of terminals that have the MU-MIMO optimal performance metric is performed by using the best CQI from each terminal in the set.

Further, in the scheduling method, the number of terminals included in the set is equal to that of data streams when in SU-MIMO mode.

Further, in the scheduling method, at least one of the step of calculating the SU-MIMO optimal performance metric and the step of calculating the MU-MIMO optimal performance metric calculates a weighted optimal performance metric by applying weighting coefficient to a data rate reflected by the CQIs.

Further, in the scheduling method, the step of switch between SU-MIMO mode and MU-MIMO mode comprises: switching to the SU-MIMO mode if the SU-MIMO optimal performance metric is larger than the MU-MIMO optimal performance metric, and switching to the MU-MIMO mode if otherwise.

Further, the scheduling method further comprises a step of, after the comparing step, allocating data rate for the selected terminal in the SU-MIMO mode or allocating data rates for the selected set of terminals in the MU-MIMO mode.

Further, in the scheduling method, when switching to the SU-MIMO mode, the data rate for the selected terminal is mapped, based on capacity or error rate criterion, from the CQIs fed back by the terminal, when switching to the MU-MIMO mode, the data rate for each terminal in the selected set is mapped, based on capacity or error rate criterion, from the CQIs fed back by the set of terminals.

Further, the scheduling method comprises a step of transmitting information determined in the comparing step to concerned terminal (s).

Further, in the scheduling method, the step of transmitting information comprises broadcasting the PVIs of all the terminals in the selected set.

According to still another aspect of the present invention, a scheduling apparatus in a MIMO control station for switching between SU-MIMO mode and MU-MIMO mode, which receives feedback information from each of a plurality of MIMO terminals, the feedback information including a PVI and corresponding CQIs, comprises: a SU-MIMO selecting unit that selects a terminal that has a SU-MIMO optimal performance metric among all the terminals; a MU-MIMO selecting unit that groups the terminals into at least one set, terminals in each set having matched codeword with each other, and selects a set of terminals that have a MU-MIMO optimal performance metric; and a switching unit that compares the SU-MIMO optimal performance metric and the MU-MIMO optimal performance metric to switch between the SU-MIMO mode and the MU-MIMO mode.

Further, in the scheduling apparatus, the SU-MIMO optimal performance metric is a maximum SU-MIMO capacity, and the MU-MIMO optimal performance metric is a maximum MU-MIMO capacity.

Further, in the scheduling apparatus, the MU-MIMO selecting unit selects the set of terminals such that columns of precoding codeword from each terminal in the set are a permutated version of those from another different terminal in the set.

Further, in the scheduling apparatus, the MU-MIMO selecting unit uses the best CQI from each terminal in the set in selecting the set of terminals that have the MU-MIMO optimal performance metric.

Further, in the scheduling apparatus, the number of terminals included in the set is equal to that of data streams when in SU-MIMO mode.

Further, in the scheduling apparatus, at least one of the SU-MIMO selecting unit and the MU-MIMO selecting unit comprises a weighting unit that calculates a weighted optimal performance metric by applying weighting coefficient to a data rate reflected by the CQIs.

Further, in the scheduling apparatus, the switching unit switches to the SU-MIMO mode if the SU-MIMO optimal performance metric is larger than the MU-MIMO optimal performance metric, and switches to the MU-MIMO mode if otherwise.

Further, the scheduling apparatus comprises a rate matching unit that allocates data rate for the selected terminal in the SU-MIMO mode or allocates data rates for the selected set of terminals in the MU-MIMO mode.

Further, in the scheduling apparatus, when switching to the SU-MIMO mode, the rate matching unit maps the data rate for the selected terminal, based on capacity or error rate criterion, from the CQIs fed back by that terminal; when switching to the MU-MIMO mode, the rate matching unit maps the data rate for each terminal in the selected set, based on capacity or error rate criterion, from the CQIs fed back by the set of terminals.

Further, the scheduling apparatus further comprises a transmitting unit that transmits information determined in the switching unit to concerned terminal (s).

Further, in the scheduling apparatus, the transmitting unit broadcasts the PVIs of all the terminals in the selected set.

According to another aspect of the present invention, a computer program product comprises codes for causing a processor to perform a method for providing feedback information to a multiple-input multiple-output (MIMO) control station from a MIMO terminal, the MIMO terminal operates, as one of a set of MIMO terminals, in a multiple-user MIMO (MU-MIMO) mode in receiving a plurality of data streams, the method comprises: determining a plurality of channel quality indicators (CQIs) respectively corresponding to the plurality of streams; determining, from a codebook, a codeword which results in a preferred single-user MIMO (SU-MIMO) performance metric; and transmitting a precoding vector index (PVI) of the determined codeword and its corresponding CQIs to the MIMO control station.

According to another aspect of the present invention, a computer program product comprises codes for causing a processor to perform a scheduling method in a multiple-input multiple-output (MIMO) control station for switching between single-user MIMO (SU-MIMO) mode and multiple-user MIMO (MU-MIMO) mode, the method comprises: receiving feedback information from each of a plurality of MIMO terminals, the feedback information including a precoding vector index (PVI) and corresponding channel quality indicators (CQIs); determining a terminal that has a SU-MIMO optimal performance metric among all the terminals; grouping the terminals into at least one set, terminals in each set having matched codeword with each other, and selecting a set of terminals that have a MU-MIMO optimal performance metric; and comparing the SU-MIMO optimal performance metric and the MU-MIMO optimal performance metric to switch between the SU-MIMO mode and the MU-MIMO mode.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of an OFDM-MIMO terminal according to an embodiment of the invention;

FIG. 2 is a block diagram of the feedback unit 17 shown in FIG. 1;

FIG. 3 is a flow chart showing processed performed by the feedback unit 17;

FIG. 4 is a block diagram of a control station 30 in a MIMO communication according to an embodiment of the invention;

FIG. 5 is a block diagram of the scheduling unit 35 shown in FIG. 4; and

FIG. 6 is a flow chart showing processed performed by the scheduling unit 35.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

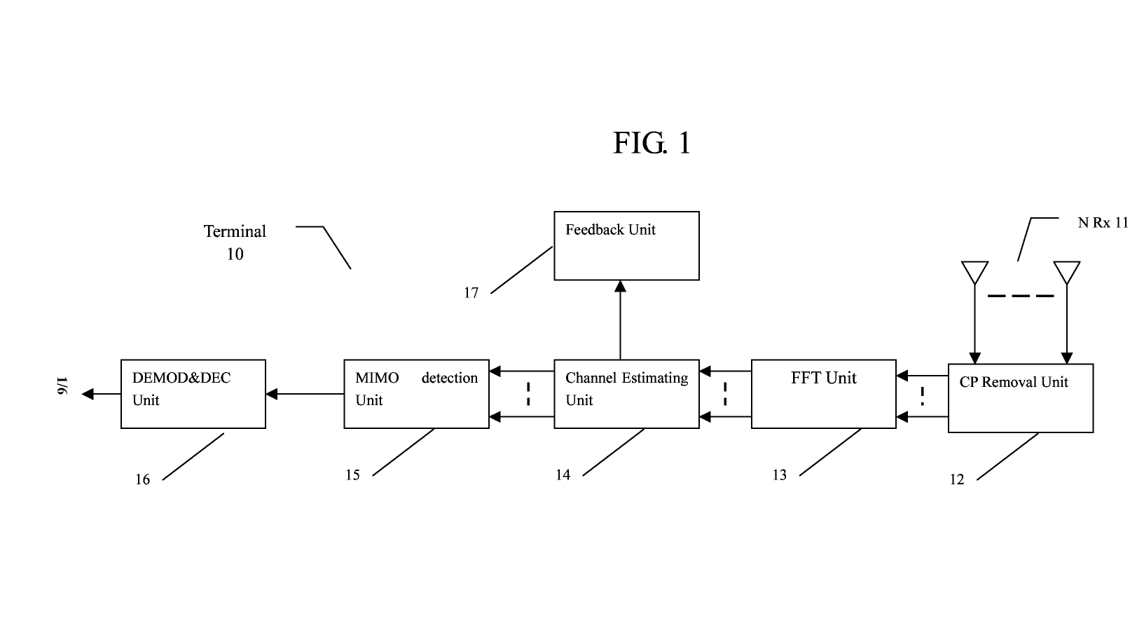

FIG. 1 is a block diagram of an OFDM-MIMO terminal according to an embodiment of the invention. As shown in FIG. 1, an OFDM-MIMO terminal 10 comprises N Rx antennas 11, a CP (cyclic prefix) removal unit 12, a FFT (Fast Fourier Transform) unit 13, a channel estimating unit 14, a MIMO detecting unit 15, a DEMOD & DEC unit 16, and a feedback unit 17. However, the terminal 10 may not necessarily be an OFDM terminal, in some cases, therefore, the CP removal unit 12 and the FFT unit 13 can be omitted.

The N Rx antennas 11 receive a plurality of multiplexed data streams. The CP removal unit 12 removes a CP portion from the data streams received by the antennas 11 when using in OFDM case. The FFT unit 13 performs a FFT process on the CP-removed data streams when using in OFDM case. The channel estimating unit 14 estimates the channels (streams) using pilot components included in the data streams, and provides a channel matrix estimated to the feedback unit 17. The MIMO detecting unit 15 detects the data streams processed by the FFT unit 13. The DEMOD & DEC unit 16 demodulates the data processed by the MIMO detecting unit 15 and decodes the demodulated data into user data.

The feedback unit 17 is equipped with a codebook (which is not shown) that stores codewords for precoding data streams transmitted from a control station (e.g. a base station). With an estimated channel matrix, each terminal can compute post-processing SINRs for each data stream as the CQIs for feedback. The post-processing SINRs are computed assuming that there are precoding weighting at the control station, and also some MIMO decoding method at the terminal, such as ZF (Zero-forcing) or MMSE (Minimal Mean Square Error), or other methods. A precoding weighting vector is determined as follows.

An appropriate precoding codeword is selected from the codebook to obtain a preferred performance metric, such as to maximize a sum rate of the post-processing SINRs, for each data stream. The selecting process may be based on sum-rate maximization, or BLER minimization, or other criterion. A PVI corresponds to one codeword in the codebook by some mapping rule which is known to both the control station and the terminal.

Further, PVIs of the determined codewords and the CQIs are fed back to the control station by the feedback unit 17.

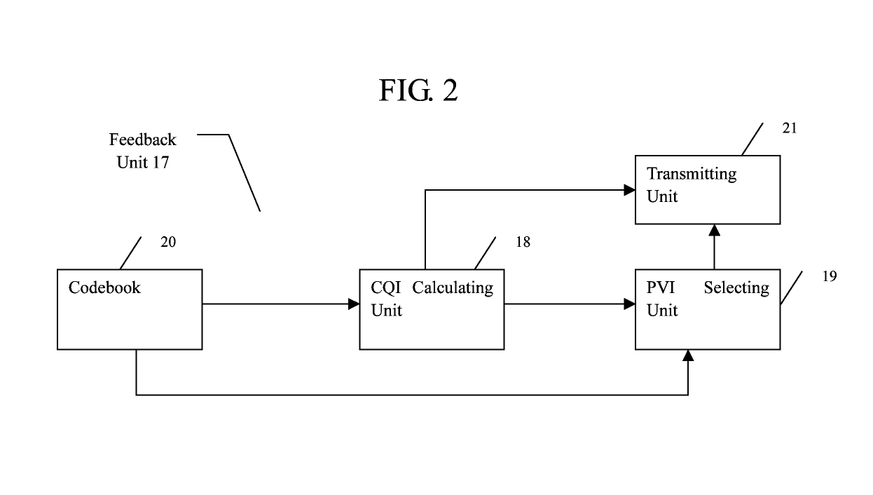

FIG. 2 is a block diagram of the feedback unit 17 shown in FIG. 1. The feedback unit 17 includes a CQI calculating unit 18, a PVI selecting unit 19, a codebook 20, and a transmitting unit 21.

Here, we illustrate our patent with a MIMO system with four Tx streams at the control station and two Rx streams at the terminal 10. However, our invention is not limited to 2-Rx and 4-Tx MIMO case, it is applicable to any number of receiver antenna and transmit antenna.

The CQI calculating unit 18 calculates multiple SINR values for each of the multiple data streams as follows:

A signal Y(k) received by the terminal 10, when assuming the control station send the data weighted by some precoding codeword, may be expressed according to the following equation 4:

$$\begin{matrix}Y ( k ) = H ( k ) W ( k ) X ( k ) + n ( k ) \\ = [ \begin{matrix}{h}_{11} ( k ) & {h}_{12} ( k ) & {h}_{13} ( k ) & {h}_{14} ( k ) \\ {h}_{21} ( k ) & {h}_{22} ( k ) & {h}_{23} ( k ) & {h}_{24} ( k )\end{matrix} ] \\ [ \begin{matrix}{w}_{11} ( k ) & {w}_{21} ( k ) \\ {w}_{12} ( k ) & {w}_{22} ( k ) \\ {w}_{13} ( k ) & {w}_{23} ( k ) \\ {w}_{14} ( k ) & {w}_{24} ( k )\end{matrix} ] [ \begin{matrix}{x}_{1} ( k ) \\ {x}_{2} ( k )\end{matrix} ] + [ \begin{matrix}{n}_{1} ( k ) \\ {n}_{2} ( k )\end{matrix} ]\end{matrix} \qquad ( 4 )$$

In equation 4, k is an index of the terminal, H(k) is a channel matrix, W(k) is a precoding matrix, X(k) is a transmission signal before precoding matrix is applied thereto, and n(k) is a noise at the terminal 10.

h₁₁(k) represents a channel vector between a first Tx antenna and a first Rx antenna, h₁₂(k) represents a channel vector between a second Tx antenna and the first Rx antenna, . . . , h₂₄(k) represents a channel vector between a four Tx antenna and the second Rx antenna. The precoding matrix W(k) is a codeword in the codebook 20, wherein w₁₁(k)˜w₁₄(k) represents a precoding vector applied to transmission signal x₁(k) for the terminal 10, and w₂₁(k)˜w₂₄(k) represents a precoding vector applied to transmission signal x₂(k) for the terminal 10′. n₁(k) and n₂(k) respectively represents noise component for the first and second Rx antenna.

Equation 4 may be rewritten as equation 5:

$$\begin{matrix}Y ( k ) = \hat{H} ( k ) X ( k ) + n ( k ) \\ = [ \begin{matrix}{\hat{h}}_{11} ( k ) & {\hat{h}}_{12} ( k ) \\ {\hat{h}}_{21} ( k ) & {\hat{h}}_{22} ( k )\end{matrix} ] [ \begin{matrix}{x}_{1} ( k ) \\ {x}_{2} ( k )\end{matrix} ] + [ \begin{matrix}{n}_{1} ( k ) \\ {n}_{2} ( k )\end{matrix} ]\end{matrix} \qquad ( 5 )$$

wherein, Ĥ(k)=H(k)W(k) is an equivalent channel. When the terminal 10 gets this received vector Y(k), we will detect each data stream assuming the MIMO detecting unit 15 will use some detection method, such as ZF, or MMSE, or other method. Here, we suppose that the MIMO detecting unit 15 uses MMSE method, which multiplies the received signal Y(k) with a matrix (Ĥ^{T}(k)Ĥ(k)+σ²I_{2×2})⁻¹ Ĥ^{T}(k), determined under MMSE criterion, as shown in equation (6):

$$\begin{matrix}\hat{Y} ( k ) = {( {\hat{H}}^{T} ( k ) \hat{H} ( k ) + {σ}^{2} {I}_{2 \times 2} )}^{- 1} {\hat{H}}^{T} ( k ) Y ( k ) \\ = [ \begin{matrix}{r}_{11} ( k ) {x}_{1} ( k ) + {r}_{12} ( k ) {x}_{2} ( k ) + {n}_{1}^{′} ( k ) \\ {r}_{21} ( k ) {x}_{1} ( k ) + {r}_{22} ( k ) {x}_{2} ( k ) + {n}_{2}^{′} ( k )\end{matrix} ]\end{matrix} \qquad ( 6 )$$

wherein, Ĥ(k)=H(k)W(k) is the equivalent channel, Ŷ(k) is the detected signal vector, Ĥ^{T} (k) is a conjugate transposition of Ĥ(k), σ² is the noise power, I_{2×2} is a 2×2 identity matrix, (Ĥ^{T}(k)Ĥ(k)+σ²I_{2×2})⁻¹ is the inverse of matrix (Ĥ^{T}(k)Ĥ(k)+σ²I_{2×2}). r₁₁(k) is the weighting factor for data stream x₁(k), r₂₂(k) is the weighting factor for data stream x₂(k), while r₁₂(k) and r₂₁(k) are cross factors due to non-ideal interference cancellation by MMSE. On the other hand, r₁₂(k) and r₂₁(k) is zero for ZF method. n′₁(k) and n′₂(k) are the noise weighted by matrix (Ĥ^{T}(k)Ĥ(k)+σ²I_{2×2})⁻¹Ĥ^{T}(k).

Then, two SINR values for these two data streams may be obtained by equation 7:

$${SINR}_{1} ( k ) = \frac{{‖ {r}_{11} ( k ) ‖}^{2}}{{‖ {r}_{12} ( k ) ‖}^{2} + E ( {( {n}_{1}^{′} ( k ) )}^{2} )} ; \\ {SINR}_{2} ( k ) = \frac{{‖ {r}_{22} ( k ) ‖}^{2}}{{‖ {r}_{21} ( k ) ‖}^{2} + E ( {( {n}_{2}^{′} ( k ) )}^{2} )} \qquad ( 7 )$$

wherein, E((n′₁(k))²) and E((n′₂(k))²) is the statistical expectation of weighted noise n′₁(k) and n′₂ (k), respectively.

Note that these two SINR values actually reflect the signal quality for each data stream, therefore decide the supportable data rate for each stream.

The PVI selecting unit 19 selects a codeword to obtain some preferred performance metric, for example, to maximize a data capacity, or minimize a transmission error rate. The preferred performance metric is not necessarily a best one (e.g. a maximum one or a minimum one), but may be a relatively good one as appropriately determined by the system. Here we illustrate the optimization process using capacity maximization criterion as to maximize the capacity summation of these two data streams, when selecting codeword from the codebook 20:

$$\{ {w}_{1} ( k ) , {w}_{2} ( k ) \} = {arg max}_{{w}_{1} , {w}_{2} ∈ W} ( \begin{matrix}log ( 1 + {SINR}_{1} ( k ) ) + \\ log ( 1 + {SINR}_{2} ( k ) )\end{matrix} ) \qquad ( 8 )$$

wherein, w₁ and w₂ are two columns of the codeword W selected from the codebook 20, each column corresponds to one weight vector for one data stream. Then the SU-MIMO capacity of this terminal can be determined based on the selected codeword and CQI by various methods, here we list one example computing theoretical SU-MIMO capacity as:

Cap_{SU-MIMO}(k)=log(1+SINR₁(k))+log(1+SINR₂(k))|_{W=[w}_{₁}_{,w}_{₂}_{]} (9)

wherein, W=[w₁,w₂] is the codeword selected in equation (8)

Then, the transmitting unit 21 sends index of the selected codeword and also the corresponding SINRs to the control station as feedback information.

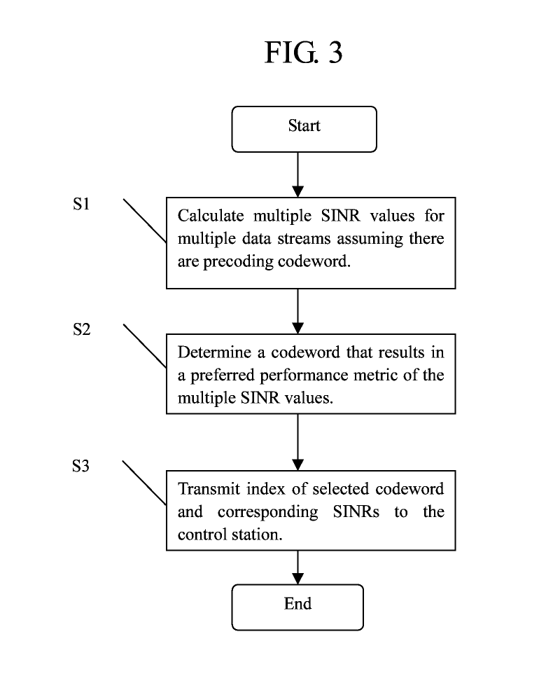

FIG. 3 is a flow chart showing processing performed by the feedback unit 17. In step S1, the CQI calculating unit 18, calculates two performance metrics (e.g. SINR values) for the two data streams received by the terminal 10 according to the above equations 4-7. In step S2, the PVI selecting unit 19 determines from the codebook 20 a codeword that results in a preferred performance metric of these two data streams, e.g. maximizes a SU-MIMO capacity of the SINRs of these two data streams according to the above equation 8. The selection processing should consider all codewords from the codebook 20, steps S1 and S2 are iteratively performed until finding the codeword satisfying equation (8). In step S3, the transmitting unit 21 transmits index of the selected codeword and also the corresponding SINRs to the control station as feedback information.

It should be noted that in the case of MU-MIMO, when we assume that each terminal knows the precoding vectors of other terminals in the determined scheduling group, we can compute the SINR using the same method as in the case of SU-MIMO mode communication in the prior art, therefore, the method for calculating SINR value at the terminal 10 is the same both for SU-MIMO and MU-MIMO mode. In other words, the present invention unifies the form of feedback information between SU-MIMO and MU-MIMO by adopting a method for calculating CQI value in MU-MIMO that is different from that in the prior art.

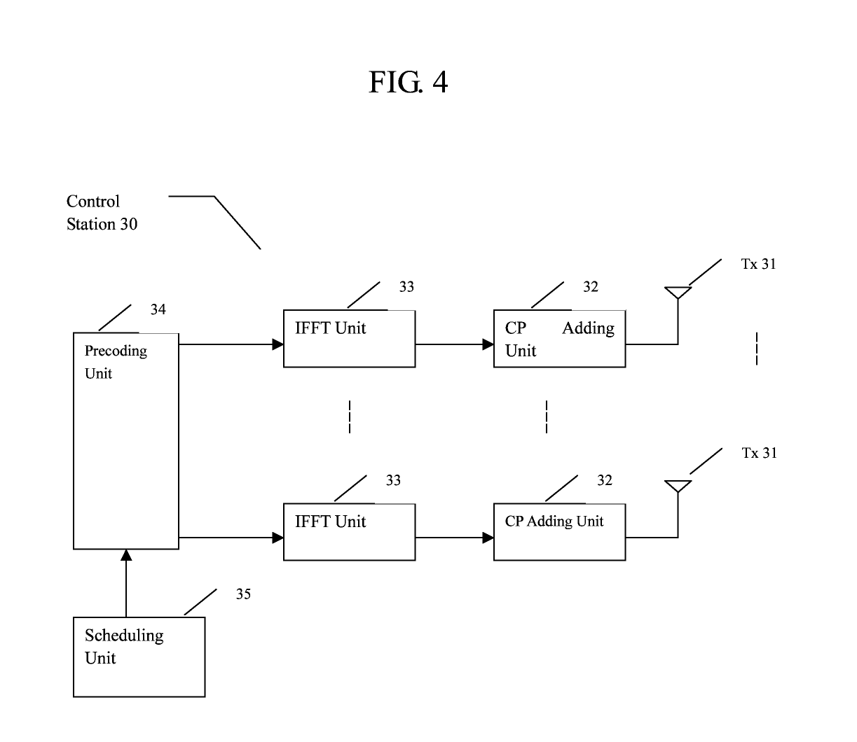

FIG. 4 is a block diagram of the control station 30 in a MIMO communication according to an embodiment of the invention. As shown in FIG. 4, the control station (base station) 30 comprises M Tx antennas 31, M CP adding units 32, M IFFT (Inverse Fast Fourier Transform) units 33 (note that the CP adding units 32 and the IFFT units 33 may be omitted when used in systems other than OFDM system), a precoding unit 34, and a scheduling unit 35.

The scheduling unit 35 retrieves feedback information from multiple MIMO terminals, which includes PVIs and corresponding CQIs (such as SINR values). With respect to all the terminals, the scheduling unit 35 performs terminal(s) selection respectively for a SU-MIMO mode and a MU-MIMO mode. The scheduling unit 35 is equipped with a codebook that contains the same contents as that in all MIMO terminals.

For the SU-MIMO mode, the scheduling unit 35 selects a terminal that has the maximum SU-MIMO capacity as shown in equation (9) among all MIMO terminals, which may be shown as:

$${Cap}_{SU} = {Max}_{k ∈ K} ( {Cap}_{SU \text{-} MIMO} ( k ) ) \qquad ( 10 )$$

here, Cap_{SU-MIMO}(k) is the SU-MIMO capacity of terminal k, K is the terminal set waiting for transmission in the system. Then this terminal and corresponding capacity can be taken as the terminal and capacity when working in SU-MIMO mode.

For the MU-MIMO mode, the scheduling unit 35 groups some terminals from all the terminals when they have matched codeword, which means that for these grouped terminals, they have the same codeword columns after any kind of column permutation. For example, we consider 2 Rx antenna case, if there exist two terminals who have the following feedback codeword, terminal 1 feeds back a codeword 1 consisting of two vectors, and terminal 2 feeds back a codeword 2 also consisting of two vectors.

Note that the codeword selected from a codebook (we call as a SU-MIMO codebook) is always consisted by two vector columns, each of which can be one codeword when used in MU-MIMO case (we call all of these vector columns as MU-MIMO codeword), which means a SU-MIMO codebook can be formed by selecting vector columns from a MU-MIMO codebook. In this way, we can decrease the memory storage required by codebook. In this case, suppose codeword 1 used by user 1 consists of vector 2 and vector 3 from a MU-MIMO codebook (here, we suppose that the vectors are sorted in terms of SINR, which means that we take the vector with the best SINR as the first vector, and so on), while codeword 2 used by terminal 2 consists of vector 3 and vector 2 from the MU-MIMO codebook. Under these assumptions, we can call user 1 and user 2 having the matched codeword, because after changing the order of the two vector columns of any one codeword, we can get two equal codewords. Similarly, we can apply this method to a case with more than two terminals.

It should be noted that it is not necessary to have the vectors sorted in terms of SINR as described above, although such sorting provides a better scheduling accuracy.

Once there exist multiple terminals which have the same column elements after permutation, then these terminals can be grouped. After we get one or more group(s) (there may be exist multiple groups with each having different column elements), we can compute the MU-MIMO capacity for each group. This capacity computation, provided that the control station broadcasts the codeword used by all the terminals for all these terminals in the selected group, will be very simple. Because for each terminal, it knows all other precoding vector columns, then it can detect its signal using ZF or MMSE or other method, treating other signals from other terminals as the different data streams from itself, only except for leaving them not detected.

In this case, the SINR computation is the same as in SU-MIMO, only different in that only one SINR is needed for MU-MIMO and multiple SINRs are needed for SU-MIMO. Note that the number of terminals of each group should be equal to the number of data streams fed back by the number of SINRs or CQIs. A set of terminals that maximizes MU-MIMO capacity is selected. Then, the scheduling unit 35 compares the capacity for SU-MIMO mode and that for the MU-MIMO mode, so as to determine which mode is chosen for communication and for which terminal(s) the communication is performed.

The precoding unit 34 obtains information of selected codewords and CQIs from the scheduling unit 35, and may determine the transmission rate for each selected user, and also applies the selected codeword to the data stream for each selected user for precoding. The IFFT units 33 perform IFFT process on the data streams precoded by the precoding unit 34. The CP adding units 32 add a CP portion on each of the data streams output from the IFFT units 33, before they are transmitted by the Tx antennas 31 to corresponding terminals. Note that these two units (22 and 23) can be omitted when used in other than OFDM systems.

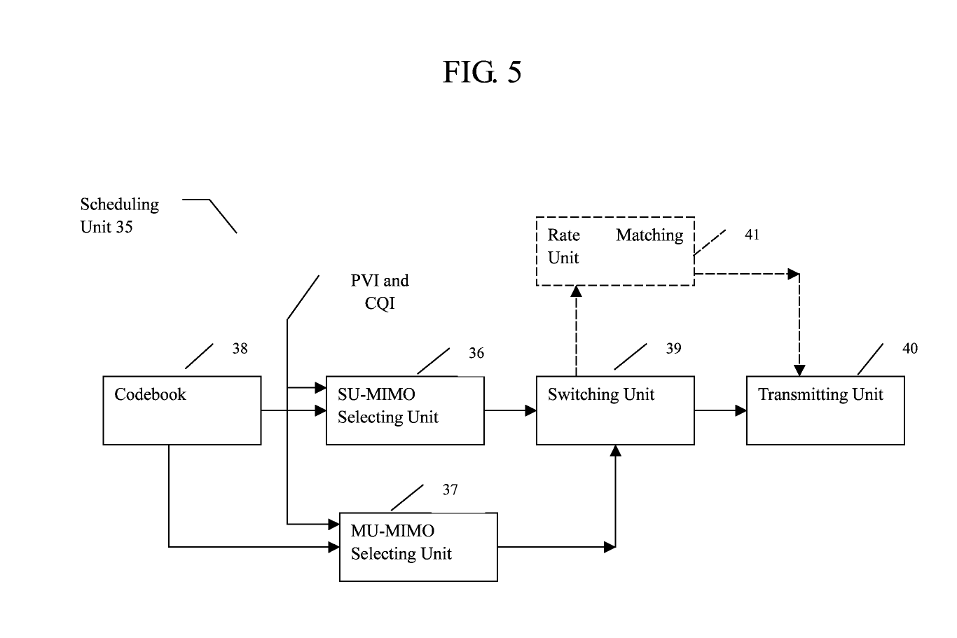

FIG. 5 is a block diagram of the scheduling unit 35 shown in FIG. 4. The scheduling unit 35 includes a SU-MIMO selecting unit 36, a MU-MIMO selecting unit 37, a codebook 38, a switching unit 39, and a transmitting unit 40. The scheduling unit 35 may further include a rate matching unit 41. The codebook 38 is the same as that in the terminals.

Here, we again use the multiple MIMO system with four Tx antennas and two Rx antennas as an example, and there are totally K terminals.

The SU-MIMO selecting unit 36 calculates a SU-MIMO capacity based on the fed back SINR₁(k) and SINR₂(k), and then selects a terminal that has the maximum SU-MIMO capacity, according to equations 11 and 12:

$$\begin{matrix}{Cap}_{SU} = log ( 1 + {SINR}_{1} ( k ) ) + log ( 1 + {SINR}_{2} ( k ) ) & ( 11 ) \\ k = {arg max}_{j ∈ \{ 1 , … , K \}} ( log ( 1 {SINR}_{1} ( j ) ) + log ( 1 + {SINR}_{2} ( j ) ) ) & ( 12 )\end{matrix}$$

wherein Capₛᵤ is the SU-MIMO capacity when working in SU-MIMO case, and k represents the index of the selected terminal.

The MU-MIMO selecting unit 37 groups two terminals according to the following rule or property, suppose there are two terminals i and j:

w₁(i)=w₂(j) and w₂(i)=w₁(j) (13)

wherein w₁ and w₂ refer to two vectors in the codeword.

Then, suppose that each of these two terminals can know the codeword the other terminal used, which can be implemented by broadcasting the codewords both for these two terminals at the control station, the SINR for each terminal when only one data stream is supposed to be transmitted to it, is computed as equation 14:

$${SINR}_{1} ( i ) = \frac{{‖ {r}_{11} ( i ) ‖}^{2}}{{‖ {r}_{12} ( i ) ‖}^{2} + E ( {( {n}_{1}^{′} ( i ) )}^{2} )} ; \\ {SINR}_{1} ( j ) = \frac{{‖ {r}_{11} ( j ) ‖}^{2}}{{‖ {r}_{12} ( j ) ‖}^{2} + E ( {( {n}_{1}^{′} ( j ) )}^{2} )} \qquad ( 14 )$$

It should be noted that, in this embodiment, preferably the SINRs and the corresponding codeword vectors are sorted when fed back so that the SINR₁ is greater than SINR₂. Therefore, in equation (14), the SINR for each selected terminal is the bigger one from the two fed back SINRs for that terminal. However, the present invention is also implemental without using the bigger SINR.

Then, the MU-MIMO capacity is calculated for the pair of terminals according to equation 15:

Cap_{MU}=log(1+SINR₁(i))+log(1+SINR₁(j)) (15)

There may be exist many groups having this property, then the MU-MIMO selecting unit 37 selects one group have a pair of terminals from all possible groups so these selected terminals have the biggest MU-MIMO capacity.

The switching unit 39 determines a communication mode between SU-MIMO and MU-MIMO according to the following expression:

$$\{ \begin{matrix}SU \text{-} MIMO , {Cap}_{SU} > {Cap}_{MU} \\ MU \text{-} MIMO , {Cap}_{SU} < {Cap}_{MU}\end{matrix}$$

Once the switching unit 39 decides the communication mode as SU-MIMO or MU-MIMO, the transmitting unit 40 may transmit the decision information to the concerned terminal(s). Specifically, if the SU-MIMO mode is decided, then the transmitting unit 40 may transmit the identity of the selected terminal, the data rate for each data stream, and PVI for precoding for this terminal. The data rate for each data stream may be determined by the rate matching unit 41 based on the SINRs of this selected terminal by capacity criterion or transmission error rate criterion or any other criterions. However, if the MU-MIMO mode is decided, the transmitting unit 40 may transmit the identity of the pair (group) of terminals, data rate for each terminal and PVI for precoding for this pair (group) of terminals, similarly the data rate for each terminal can be determined by the rate matching unit 41 based on the SINRs of each terminal by capacity criterion or transmission error rate criterion, or any other criterions. The rate matching unit 41 is not necessarily to be disposed in the scheduling unit 35, but may be disposed in other units such as the precoding unit 34.

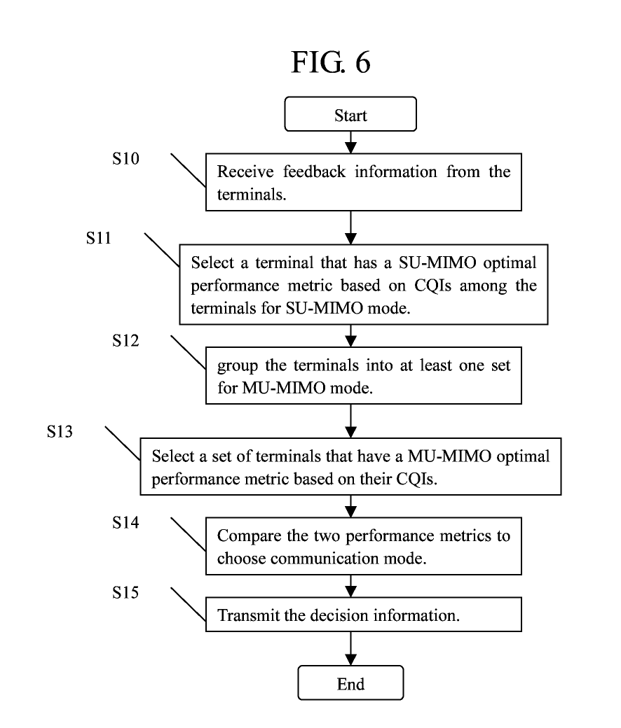

FIG. 6 is a flow chart showing processing performed by the scheduling unit 35. In step S10, the scheduling unit 35 receives feedback information from all terminals, which includes a PVI and corresponding CQIs. In step S11, a SU-MIMO capacity is determined when suppose it works in SU-MIMO mode, and the terminal that has a maximum SU-MIMO capacity among the terminals is selected. In step S12, a MU-MIMO capacity is determined when suppose it works in MU-MIMO mode, the terminals are grouped into at least one set, wherein terminals in each set have the same precoding vector column after any column permutation. In step S13, a group of terminals that maximizes the MU-MIMO capacity is selected as the candidates for MU-MIMO communication. In step S14, the maximum SU-MIMO capacity obtained in step S11 and the maximum MU-MIMO capacity obtained in step S13 are compared to choose between the SU-MIMO mode and the MU-MIMO mode. Then, in step S15, the decision information is broadcasted to the concerned terminals.

It should be noted that, despite the flowchart illustrated in FIG. 6, the process for calculating SU-MIMO capacity (step S11) may be performed after the process for calculating MU-MIMO capacity (steps S12 and S13), and even the two processes may be performed at the same time in parallel.

As previously mentioned, the present invention is not restricted to the above-described embodiments. The present invention can have various modifications within the range of the technical concept of the present invention.

In the embodiments, when calculating the sum capacity in the scheduling unit 35, it is simply a combination of CQIs without considering other issues. For a more flexible scheduling, a weighted sum capacity algorithm may be adopted instead.

Specifically, a weighting unit may be provided in the scheduling unit 35 to apply weighting coefficients to the rate reflected by CQIs when calculating the sum capacity. The weighting coefficients may be chose according to priority of user and any other issues. In implementing the weighted sum capacity scheme, certain scheduling algorithm may be used, such as proportional fair scheduling method.

Further, in the embodiments, for the purpose of giving a more clear description of the invention, the set of terminals for calculating CQI in SU-MIMO mode in the scheduling unit 35 has two data streams, correspondingly, the number of terminals selected in MU-MIMO mode is also 2. However, the present invention is not restricted to the embodiments, and is applicable to situations where the number of data streams are more than two in SU-MIMO mode, or more than 2 terminals may be selected in MU-MIMO mode, as can be appreciated by those skilled in the art in light of the specification.

Additionally, the equations involved in calculating CQI (SINR) and the sum capacity are merely examples for explaining the relevant calculating procedure, and various other equations with similar function may also be applied to the present invention. For example, maximizing the sum capacity can be substituted by maximizing the minimal capacity of two data streams which describes the error rate to some extend determined by the worse data stream. Other examples of performance metric include combining the QoS information from the higher layer into the physical layer capacity, and so on. In general, the present invention is applicable to various suitable algorithms that can obtain an optimal performance metric of a MIMO terminal.

Furthermore, while the linear post-processing SINR is explained in the embodiments for representing CQI, the present invention can be similarly implemented using other parameters as CQI, such as non-linear post-processing SINRs (MLD method, or other non-linear methods).

The present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method for providing feedback information to a multiple-input multiple-output (MIMO) control station from a MIMO terminal, which operates as one of a set of MIMO terminals in a multiple-user MIMO (MU-MIMO) mode in receiving a plurality of data streams, comprising steps of:
calculating a plurality of channel quality indicators (CQIs) respectively corresponding to the plurality of streams;
determining, from a codebook, a codeword which results in a preferred single-user MIMO (SU-MIMO) performance metric; and
transmitting a precoding vector index (PVI) of the determined codeword and its corresponding CQIs to the MIMO control station.

2. A feedback apparatus in a multiple-input multiple-output (MIMO) terminal, which operates as one of a set of MIMO terminals in a multiple-user MIMO (MU-MIMO) mode to communicate with a MIMO control station in receiving a plurality of data streams, the feedback apparatus comprising:
a channel quality indicator (CQI) calculating unit that determines a plurality of CQIs respectively corresponding to the plurality of streams;
a precoding vector index (PVI) selecting unit that determines, from a codebook, a codeword which results in a preferred single-user MIMO (SU-MIMO) performance metric; and
a transmitting unit that transmits PVI of the determined codeword and its corresponding CQIs to the MIMO control station.

3. A scheduling method in a multiple-input multiple-output (MIMO) control station for switching between single-user MIMO (SU-MIMO) mode and multiple-user MIMO (MU-MIMO) mode, comprising steps of:
receiving feedback information from each of a plurality of MIMO terminals, the feedback information including a precoding vector index (PVI) and corresponding channel quality indicators (CQIs);
determining a terminal that has a SU-MIMO optimal performance metric among all the terminals;
grouping the terminals into at least one set, terminals in each set having matched codeword with each other, and selecting a set of terminals that have a MU-MIMO optimal performance metric; and
comparing the SU-MIMO optimal performance metric and the MU-MIMO optimal performance metric to switch between the SU-MIMO mode and the MU-MIMO mode.

4. The scheduling method of claim 3, wherein the SU-MIMO optimal performance metric is a maximum SU-MIMO capacity, and the MU-MIMO optimal performance metric is a maximum MU-MIMO capacity.

5. The scheduling method of claim 3, wherein the set of terminals are selected such that columns of precoding codeword from each terminal in the set are a permutated version of those from another different terminal in the set.

6. The scheduling method of claim 3, wherein the step of selecting a set of terminals that have the MU-MIMO optimal performance metric is performed by using the best CQI from each terminal in the set.

7. A scheduling apparatus in a multiple-input multiple-output (MIMO) control station for switching between single-user MIMO (SU-MIMO) mode and multiple-user MIMO (MU-MIMO) mode, which receives feedback information from each of a plurality of MIMO terminals, the feedback information including a precoding vector index (PVI) and corresponding channel quality indicators (CQIs), the scheduling apparatus comprising:
a SU-MIMO selecting unit that selects a terminal that has a SU-MIMO optimal performance metric among all the terminals;
a MU-MIMO selecting unit that groups the terminals into at least one set, terminals in each set having matched codeword with each other, and selects a set of terminals that have a MU-MIMO optimal performance metric; and
a switching unit that compares the SU-MIMO optimal performance metric and the MU-MIMO optimal performance metric to switch between the SU-MIMO mode and the MU-MIMO mode.

8. The scheduling apparatus of claim 7, wherein the SU-MIMO optimal performance metric is a maximum SU-MIMO capacity, and the MU-MIMO optimal performance metric is a maximum MU-MIMO capacity.

9. The scheduling apparatus of claim 7, wherein the MU-MIMO selecting unit selects the set of terminals such that columns of precoding codeword from each terminal in the set are a permutated version of those from another different terminal in the set.

10. The scheduling apparatus of claim 7, wherein the MU-MIMO selecting unit uses the best CQI from each terminal in the set in selecting the set of terminals that have the MU-MIMO optimal performance metric.
